(19) United States
(12) Patent Application Publication
(10) Pub. No.: US 2011/0320163 A1
(43) Pub. Date: Dec. 29, 2011

(54) METHOD AND SYSTEM FOR DETERMINING ROAD DATA

(75) Inventors: Gustav Markkula, Goteborg (SE); Fredrik Sandblom, Goteborg (SE)

(73) Assignee: VOLVO TECHNOLOGY CORPORATION, Goteborg (SE)

(21) Appl. No.: 13/127,981

(22) PCT Filed: Nov. 6, 2008
(86) PCT No.: PCT/SE2008/000631

§ 371 Date: Jun. 10, 2011

(51) Int. Cl. G06F 15/00

(52) U.S. Cl. 702/150

(57) ABSTRACT

A method, a system and a computer program are provided for determining road data including the steps of: (i) measuring variables suitable for determining an actual trajectory (A) of the vehicle; (ii) determining the actual trajectory from the measured variables; (iii) estimating road geometry values based on the determined actual trajectory; and (iv) determining a virtual road the vehicle is following based on the estimated road geometry data and the actual trajectory.

### BACKGROUND AND SUMMARY

The present invention relates to a method and a system for determining road data.

Knowledge of the road a vehicle is travelling is the basis for the determination whether an actual trajectory is in a normal range or whether a lateral offset or a pattern of lateral offsets between an ideal and the actual trajectory may indicate a deteriorated lateral control performance of the driver.

An ideal trajectory means a path the vehicle should have followed on a real road under a driver's optimal lateral control performance, i.e. the ability of the driver to keep a lane or to follow a desired path. An actual trajectory means the path the vehicle has in fact followed.

A deteriorated lateral control performance in turn can be an indication for inattentiveness of the driver caused by e.g. drowsiness, distraction and/or workload. Therefore, in a plurality of methods and systems known from the state of the art the lateral offset between actual trajectory and a lane of a real road is used as measure for assessing a driver's inattentiveness.

For example, U.S. Pat. No. 6,335,689 suggests to determine the road a vehicle is travelling by using a CCD camera imaging a left or right lane marker of a road. The vehicle position within the lane can be calculated from the lateral distance from the center of vehicle to the left lane marker and the road width. Instead of cameras, also a road-vehicle communication system based on magnetic nails buried beneath roads can be used, and a navigation system based on GPS can be used to detect lateral displacements. Further, since it is possible to detect lateral displacement from steering angles, the lateral displacement detecting section can use a steering angle sensor. Furthermore, the lateral displacement may be estimated by detecting yaw rate or lateral acceleration. The lateral sway or fluctuation of the vehicle is measured and data of displacement quantity is stored for obtaining frequency components power. Dependent on the frequency of the lateral displacements, the system can determine whether a driver is inattentive or not.

U.S. Pat. No. 7,084,773 refers to the problem that by using the frequency based approach for detecting the wakefulness of a driver, an accurate estimation of the drivers wakefulness is not always possible. For example, on a highway between mountains and having successive curves in different winding directions, a driver who is at a normal level of wakefulness drives the car by turning the steering wheel to the left and right at relatively small steering angles. The turning of the steering wheel in such a case is likely to be extracted as a low frequency component used for determination of stagger, which can cause an erroneous determination. Therefore, the method described in this document uses a road-shape-based correction value to refer to roads having a plurality of curves. The road-shape-based correction value is derived from the output of a lane tracking sensor, which recognizes left and right lane markings located ahead the vehicle in the travelling direction thereof based on an image obtained by a stereoscopic camera or single-lens camera utilizing a CCD (solid-state image pickup device) loaded on the vehicle. In order to obtain accurate data on displacements in the lane, a lane recognition result correction unit identifies the type of the lane markings drawn on the road as one of a plurality of preset lane marking types based on a recognized lane width. The lane width is obtained from the difference between the positions of the left and right lane markings recognized by a lane tracking sensor. The lane recognition correction unit further detects displacements (lateral displacements) of the vehicle in the direction perpendicular to the driving direction of the vehicle based on the lane marking type thus identified.

In all above cited exemplary methods for determining the position of the vehicle in relation to the road a “lane tracker” sensor is used, which is capable of measuring the vehicle's actual position on the road or in a lane, and optionally also the shape of the forward roadway, wherein lane boundaries or the road itself define the ideal trajectory. Lane trackers can be based on a number of different technologies, the most common being a forward looking camera sensor. Camera sensors mounted in vehicles to measure lane positions are available on the market since some time and are intended to warn the driver when a lane boundary is unintentionally crossed (“lane departure warning”).

In some cases the time scales for informing a driver of a deteriorated lateral control performance need not to be minimised to the same extent as e.g. for lane departure warnings, collision warnings or other time critical systems. Especially, in case an inattentiveness of the driver should be detected, the time scale can be extended up to several ten seconds or even minutes instead of only a few seconds or times less than a second. The reason for this possible extension is that a driver's inattentiveness, e.g. drowsiness, is a slow process and evolves rather within several ten seconds or even minutes instead of seconds. This provides the opportunity to draw conclusions on the driver's state based on the sensed actual trajectory, e.g. it is possible to use past-time data gathered from sensors sensing the actual position of the vehicle.

Such a system and method is, for example, described in EP 1 672 389 A1, wherein the actual trajectory of the vehicle along a road, and the road itself are determined by data representatives of the vehicle's environment, i.e. the vehicle's lateral position in relation to the road, and appropriate vehicle state parameters such as vehicle speed and yaw rate, wherein the road or lane is preferably observed by a lane tracking system. On the basis of gathered information on vehicle dynamics (e.g. yaw rate) at a previous point in time, the known system and method calculate an estimate of the driver's planned path, i.e. the path that the driver seemed to intend to follow at the previous point in time, and compares this planned path with the actual observed lane. A deviation between actual road geometry and the driver's planned path in the previous point in time is considered an indicator of driver inattentiveness. For determining the data representatives of the vehicle's environment a lane position system, for instance a camera such as a forward looking mono-camera is used.

The main disadvantage of the known systems is that the sensors for determining the vehicle's environment, particularly a camera for determining the vehicle's position in relation to a lane, are limited in robustness and reliability. It may for instance happen that at certain times sensor data are incorrect or not available at all. This can be due to technical limitations of the sensor itself, but also due to external problems such as poorly or not at all visible lane markings, caused by road wear, or by e.g. water or snow covering the markings. Additionally, using a lane tracker sensor will increase the cost of the whole system, since the costs of a camera and of the computing hardware necessary to perform the processing of camera images need to be added.

Additionally, using measurements of the steering wheel angle or of the vehicle yaw rate, rather than vehicle lateral position information, for estimation of driver drowsiness, inattention or similar, as in some prior art, is difficult, since individual driver behaviors and/or environmental impacts, such as side wind effects induce a lot of variance in the steering wheel angle and yaw rate signals, and this may impair the estimations.

It is desirable to provide a more accurate, robust and cost-effective method and system for determining road data.

The invention is based, according to an aspect thereof, on the idea that instead of detecting the actual road geometry by sensing lane markings or other indicators of the real road by means of camera sensors and the like, the road geometry values are estimated based on the actual path the vehicle is travelling, whereby knowledge of road design practices and/or on typical physical constraints on roads are used. With other words instead of observing or sensing the shape of the real road by means of lane tracker systems, a virtual road is determined, which provides basically the same data as the lane tracker system, but with a certain time delay. The virtual road in turn can serve as basis for the determination whether the actual path of the vehicle is in a normal range or not.

This approach is possible since roads are planned according to special boundary conditions, i.e. the road geometry is for example limited by specified maximum bend curvatures, and typically these maximum bend curvatures depend on the type of road, e.g. a highway has a lower maximum bend curvature than a mountain pass. Such boundary conditions for planning a course of a road are known facts and are therefore considered in the calculation models of the present invention. Further, in addition to simple thresholds on maximum bend curvature values, the evolution over distance of the curvature of roads also typically follows well-defined models, e.g. for planning the course of a road in Europe a so-called clothoid model is used, and such models can therefore preferably be used for defining the virtual road.

The estimation of road geometry values itself is known from the state of the art for validating the performance of sensor systems, particularly tracking and navigation systems, where the output of the sensor data need to be compared to reference data. The reference data can be obtained e.g. by using data from a GPS system, but GPS gives often only a more accurate measurement. A new approach is suggested in the article: “Obtaining reference road geometry parameters from recorded sensor data”, from Andreas Eidehall and Fredrik Gustafsson, published at Intelligent Vehicle Symposium 2006, Jun. 13-15, 2006, Tokyo, Japan, p. 256-260. In this article, the authors suggest to use estimated road geometry values as reference data, and also state that in case an appropriate mathematical algorithm is used as basis for the estimation, the obtained results can be used as reference data for tracking and navigation systems. Even if, the disclosed model based estimation of road geometries might also be able to estimate a vehicles lateral position in the lane, this parameter is measured by a vision system, i.e. a camera, in order to improve the accuracy of the other parameter.

According to the invention, it has been additionally taken into account that in some cases the time scales for informing or warning a driver of a deteriorated lateral control performance need not to be minimised to the same extent as e.g. for lane departure warnings, side collision warnings or other time critical systems. This opens the possibility to use the inventive virtual road approach also as basis for slowly evolving lateral control performances. Therefore, it should be explicitly noted that the inventive method and system disclosed herein is not intended to be used for time-critical driver warnings.

In case the deteriorated lateral control performance is due to a slowly evolving inattentiveness of the driver, e.g. drowsiness, and/or certain distraction and/or workload types, the time scale can be extended up to several ten seconds or even minutes instead of a few seconds or times less than a second. This provides the opportunity to use different approaches, namely determining the virtual road, whereby sensor data from technically complex and costly sensors can be replaced by data from more robust sensors, which are also suitable to provide data for determining an actual trajectory of the vehicle. For example, a vehicle speed sensor and a yaw rate sensor or a yaw rate sensor alone can be used, but also other data, such as vehicle position, acceleration and/or yaw angle can be incorporated, whereby a relatively simple motion model is used. Instead of using a yaw rate sensor, the vehicle's yaw rate can also be determined by a steering wheel angle sensor.

For determining the actual trajectory, it has proven suitable to use sensor data S. The sensor data S are preferably a time series of sensor measurement data and can comprise at least vehicle speed data and vehicle yaw rate data. Additionally, the sensor data can comprise vehicle position data, vehicle yaw angle data and/or longitudinal/lateral acceleration data and/or data of any other inertia sensor.

In a preferred embodiment, the determination of the virtual road is performed by model based signal processing methods, such as fitting a parametric curve, such as a cubic spline, to the determined actual trajectory, by e.g. a weighted or non-weighted least square method. This provides a noise reducing, averaging effect to the gathered signals. This in turn means that the use of measurements of the steering wheel angle or the vehicle's yaw rate—which have a high variation due to individual driver behaviors and environmental impacts—does not deteriorate the result of the determination of the virtual road. Additionally, information based on travelling speed and/or information on road type from map data can be taken into account for the fitting of the parametric curve.

Also or alternatively, GPS data on the vehicle's position or road map data can be taken into account for the determination of the virtual road itself. One situation when this is especially preferable is if the geometry of the road on which the vehicle is travelling does not comply with standard models for road design. Additionally, further information as for example individual driver behavior can be regarded.

In another preferred embodiment, actual trajectory and virtual road are determined using model based signal processing methods or more generally statistical signal processing methods. Actual trajectory and virtual road can be described by state vectors, ak for the actual trajectory and vrk for the virtual road, containing at least position and/or heading. Further state parameters, e.g. including derivatives of position and heading can be included. The measurement and state vectors can be used in linear and/or linearized filtering algorithms, such as Kalman filter based tracking, if using linear process, and measurement models, and/or extended and/or unscented Kalman filter tracking frameworks for nonlinear models, e.g. bicycle motion model.

Also, Monte Carlo methods, e.g. particle filters, can be suitable to determine the virtual road. Particularly, the use of a Monte Carlo method based estimation is preferred, since also the actual trajectory can be included into the state vector and possible maneuvers performed by the driver, can be included as possible hypotheses with associated probabilities.

Since the results need not be provided immediately, a restriction of the estimating strategy for the road geometries or the virtual road, respectively, or any other of the mentioned parameters to causal methods, is not necessary.

Since the virtual road can be regarded as an estimate of the actual road geometry, deviations, i.e. lateral offsets between the actual trajectory and the virtual road may be used to judge a driving performance or driving effort of the driver. The lateral offset can therefore be regarded as an estimate of how close the driver manages to stay to the desired path of his vehicle. Thus, it is possible to draw a conclusion on the lateral control performance of the driver from an amount and/or a shape of the lateral offset of the actual trajectory from the virtual road. Nevertheless, it should be noted that for any driver, even in situations where driver attention and effort are within safe ranges, there will typically be a certain amount of lateral swaying in a lane. The main reason for this is that human drivers usually deem deviations from a given trajectory within a certain deviation range to be acceptable.

By determining the virtual road from the actual trajectory, particularly by estimating road geometry data, the present invention is less sensitive to natural lane position variations induced by driver behaviors such as curve-straightening or curve-cutting, lane changing or overtaking.

Since, as described above, certain driver assistance systems work on long time scales—for example drowsiness detection and warning systems, the inventive methods and the inventive systems can be used in these driver assistance systems providing a robust and cost effective possibility to detect lateral offsets caused by e.g. driver drowsiness, inattention, distraction, or insufficient driver effort. This has the further advantage that already existing sensors or standard equipment sensors can be used (e.g. a yaw rate or steering wheel angle sensor and a speed sensor) so that already existing vehicle models or vehicle platforms can be equipped with the inventive method and system with no impact or a limited impact on the vehicle hardware setup. Even if measurements of the steering wheel angle or the vehicle's yaw rate include variance that is due to individual driver behaviors and environmental impacts, these data can be used in the inventive method and system without deteriorating the result, since the calculation of the virtual road can take into account these factors.

In a further advantageous embodiment the driver assistance system working on long times scales further comprises an HMI (Human Machine Interface) for enabling (i) the interaction between the system according to the invention and the driver of the vehicle via e.g. an input to a driver assistance system, such as a drowsiness detection system and/or (ii) providing a memory for storing a driver's behavior profile. This has the advantage that the system is capable of learning and can therefore be adapted to individual drivers or individual driving behaviours. Additionally, a driver can manually provide further road data by e.g. defining that the road he is travelling is e.g. a highway.

Further advantages and preferred embodiments of the invention are defined in the claims, the description and/or the figures.

### BRIEF DESCRIPTION OF THE DRAWINGS

In the following the invention will be described by means of a preferred embodiment. The described embodiment is exemplary only, and is not intended to be used to restrict the scope of the invention thereto.

The figures show:

FIG. 1: a flow diagram of a preferred embodiment of the inventive method;

FIG. 2: a schematic illustration of the calculation principle for determining a lateral offset between an actual trajectory and a virtual road;

FIG. 3: a schematic illustration of the lateral offset of the actual trajectory from the virtual road; and FIG. 4: a diagram showing experimentally derived data of the actual trajectory and the virtual road according to the present invention in comparison with data gathered from a lane tracker sensor known from the state of the art.

### DETAILED DESCRIPTION

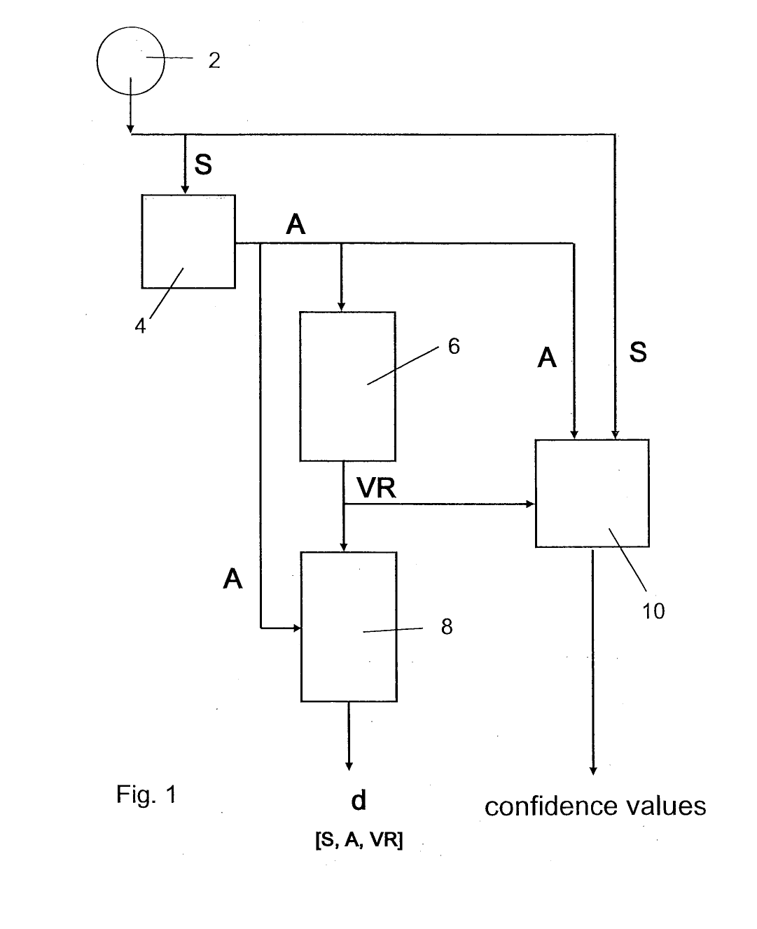

FIG. 1 illustrates a preferred embodiment of the present invention, wherein the circle referenced by reference number 2 illustrates at least one sensor providing suitable data S for determining an actual trajectory A of the vehicle. The meaning of S, A, VR, and d, will be explained below. The boxes 4, 6, 8 and 10 refer to calculation steps of calculation units, wherein in calculation step 4, the actual trajectory A is determined from the sensor data S. In next step 6, a virtual road VR is determined from the actual trajectory A. The deviation or lateral offset between the actual trajectory A and the virtual road VR is determined in calculation step 8. Box 10 indicates a calculation step, wherein a confidence is determined based on the sensed sensor data S, the determined actual trajectory A and the estimated virtual road VR. In the following the FIG. 1 and the schematically illustrated steps will be explained in more detail.

As explained above a sensor or a sensor network provides sensor data S. Such a sensor can be for example a vehicle's yaw rate sensor and a vehicle's speed sensor. But also other data, such as vehicle position, acceleration and/or yaw angle can be incorporated. These data are preferably comprised in a so called sensor measurement data matrix denoted by Sk=(S1,S2, . . . Sk), wherein Sk contains a time series of measurements data vectors Sj, with 1<j<k, wherein S1 are all sensor data taken at a time ti, S2 are all sensor data taken at a time t2, and so on. The subscript k is the current (latest) time of the system, corresponding to time ̂. Since the time in the system is measured as steps of system time unit T3 the time tk can also be written as tk=k×Ts wherein TS describes a system sample rate, that means the rate at which data measured by the sensors are read out and temporarily stored for further processing. T3 can be therefore also regarded as time unit of the calculation system.

Preferably, the vehicle comprises sensors for providing data on the (horizontal) vehicle position x(t) and y(t), the vehicle's heading determined from yaw angle data ψ(t), the vehicle yaw rate ω(t) and the vehicle speed v(t). Therefore, the measurement vector has the quantities [x, y, ψ, v, ω], from which the actual trajectory A can be calculated (as the sensor data, the actual trajectory has the form of a matrix Ak=(a1,a2, . . . ak) comprising vehicle state vectors ai,a2, . . . ak). It is also possible to take into account the vertical position z(t) of the vehicle and include it into the state vector. Particularly, if a vehicle is travelling up or down a hill, the vertical position z(t) of the vehicle changes and also the lateral movements may differ. By taking information of the vertical position z(t) into account, the probability of false interpretations of the source of lateral movements can be further reduced.

The sensor data matrix Sk=(S1,s2, . . . Sk), contains all sensor data provided in the time since the start of the system (e.g. since the vehicle ignition was turned on) and serves as input for calculating, by means of the calculating unit 4 (FIG. 1), the actual trajectory, i.e. the actual path that the vehicle has followed. Therefore, from the sensor data the actual trajectory state matrix Ak=(a-i, a2, . . . ak) is produced.

As the sensor data matrix Sk, also the actual trajectory matrix Ak=(a1,a2, . . . ak) contains a time series of vehicle states aj, with 1<j<k, which comprises the corresponding data for the actual trajectory, such as vehicle position, and heading, derived e.g. from the yaw angle ψ, and additional parameters, e.g. first derivates thereof, as well as other states depending on the choice of vehicle motion model. The calculation step 4 can be performed in an individual device of the inventive system or can be part of an already existing on-board computer which has been adapted to run a computer program of which the program code is based on the inventive method.

In the above description it has been said that matrices Sk and Ak denote all sensor and actual trajectory data since the system started operating. In practice, for reasons of memory limitations, only later portions of this data may actually be stored in the system (preferably on a first-in-first-out (“FIFO”) basis). In that case data older than a predefined number of time steps may be discarded by the system.

The time interval TS between the determination of two subsequent measurement vectors, or the length of the time series of vehicle states can be adjustable or can have a constant pre-set value. Advantageously, the time intervals are adjustable, whereby the system is adaptable to different driving behavior and situations.

The actual trajectory matrix Ak=(a1,a2, . . . ak) can be determined by initialising ai to be an initial vehicle state vector (initial position and heading may be chosen arbitrarily), and then e.g. by using the following set of equations (motion model) to calculate the needed quantities:

$${a}_{2} = ( \begin{matrix}x ( {t}_{2} ) = x ( {t}_{1} ) + v ( {t}_{1} ) \cdot Δ {t}_{1 , 2} \cdot cos ψ ( {t}_{1} ) \\ y ( {t}_{2} ) = y ( {t}_{1} ) + v ( {t}_{1} ) \cdot Δ {t}_{1 , 2} \cdot sin ψ ( {t}_{1} ) \\ ψ ( {t}_{2} ) = ψ ( {t}_{1} ) + ω ( {t}_{1} ) \cdot Δ {t}_{1 , 2}\end{matrix} )$$

$${a}_{3} = ( \begin{matrix}x ( {t}_{3} ) = x ( {t}_{2} ) + v ( {t}_{2} ) \cdot Δ {t}_{2 , 3} \cdot cos ψ ( {t}_{2} ) \\ y ( {t}_{3} ) = y ( {t}_{2} ) + v ( {t}_{2} ) \cdot Δ {t}_{2 , 3} \cdot sin ψ ( {t}_{2} ) \\ ψ ( {t}_{3} ) = ψ ( {t}_{2} ) + ω ( {t}_{2} ) \cdot Δ {t}_{2 , 3}\end{matrix} )$$

$$⋮$$

$${a}_{k} = ( \begin{matrix}x ( {t}_{k} ) = x ( {t}_{k - 1} ) + v ( {t}_{k - 1} ) \cdot Δ {t}_{k - 1 , k} \cdot cos ψ ( {t}_{k - 1} ) \\ y ( {t}_{k} ) = y ( {t}_{k - 1} ) + v ( {t}_{k - 1} ) \cdot Δ {t}_{k - 1 , k} \cdot sin ψ ( {t}_{k - 1} ) \\ ψ ( {t}_{k} ) = ψ ( {t}_{k - 1} ) + ω ( {t}_{k - 1} ) \cdot Δ {t}_{k - 1 , k}\end{matrix} )$$

where Δtk−1,k is the time between two consecutive measurement points k−1 and k, which is often, but not necessarily, equal to Ts, as described above.

In another embodiment of the invention, the algorithm includes linear or linearized filtering algorithms, such as Kalman filter based tracking, to achieve a more robust trajectory determination. In this embodiment a state vector with quantities [x, y, ω, v, ω, a] (a being the longitudinal acceleration along the direction of driving), has proven well suited to describe the actual vehicle trajectory, using a model with a filter, e.g. a simplified bicycle model and/or an unscented Kalman Filter tracking framework.

In a third embodiment a non-linear optimization methods is used, where the vehicle's actual trajectory A is calculated by using e.g. Monte Carlo methods such as a particle filter. This is particularly suited to cope with the situation where there is no unique model that describes the road properly, for example at lower speeds, particularly below e.g. 70 km/h. Similarly, maneuvers such as lane change maneuvers or overtakes can be modelled and included in the tracking. Similar behavior could be expected from a multiple hypotheses framework for linear or linearized filters as mentioned earlier.

Determination of the virtual road VR is performed in the calculation step 6 in FIG. 1. Again the calculation step 6 can be performed in an individual device of the inventive system, but it is also possible that e.g. an existing on-board computer performs the calculation. Or, the determination can be performed in the same calculation unit as the determination of the actual trajectory, but it is also possible to use a separate calculation unit.

For determining the virtual road VR, road geometries are estimated based on the determined actual trajectory A. But it is also possible to adapt the calculation of the virtual road by taking into account specific requirements of an application or applications using the output of the invention. For example, in a preferred embodiment, the output of the inventive system and method are used as input for e.g. both a driver assistance system and a fuel consumption efficiency system. Then, the calculation of the virtual road which produces an input for the driver assistance system can take into account parameters which are interesting for this driver assistance system, e.g. an individual steering behavior of a driver. In case the calculation of the virtual road produces an input for the fuel consumption efficiency system, the calculation of the virtual road can take into account e.g. the type of the road, i.e. highway, mountain pass etc. Additionally, the invention can take into account unintentional movements, which can be caused e.g. by a driver's inattentiveness, but also by external environmental conditions, as e.g. side wind or ice/snow/water on the road.

Since the virtual road VR can be parameterized as if it was a road, it can also be regarded as a matrix VRk=(vr1,vr2, . . . vrk) containing a time series of virtual road states vectors v1−j, for 1<j<k.

Even if the actual trajectory can be determined with sufficient accuracy in real time, the virtual road VR cannot be determined for the same point in time as the actual trajectory, since the system has to wait for a certain, preferably predetermined, period of time to have sampled enough information on the actual trajectory of the vehicle for estimating road geometry values and deriving the virtual road VR therefrom. If for instance a vehicle has been travelling along a straight line for a while, then if a yaw rate is detected the system does not know whether this yaw rate originates from a bend in the road or from the driver temporarily staggering in the lane. However, the system can determine the actual trajectory of the vehicle based on the sensed sensor data. But, for determining the virtual road, the system needs more information on how the actual trajectory changes over time. Therefore, the system has to wait for a certain amount of time, e.g. some seconds, or—with the notation of above—for a certain delay in time expressed in multiples m*TS of the time unit Ts before estimations of road geometries or calculations of the virtual road can be considered reliable, and therefore only the first k-m elements of the virtual road matrix VRk are used and/or output by the inventive system. Therefore, the actual trajectory matrix Ak and the virtual road matrix VRk−m differ in time by a delay of m×Ts. This delay m×Ts can be either a constant time period (m=constant) or, preferably, a variable time period e.g. depending on the vehicle speed. That means that the actual trajectory matrix Ak=(a1,a2, . . . ak) in fact determines a virtual road matrix VRk−m=(vr1,vr2, . . . vrk.m). But that also means that the inventive system and method basically give the same information as a lane tracker sensor, only at a later point in time than the lane tracker sensor.

The vehicle state vector, aj, and the virtual road state vector, can each contain the same types of data (but are not restricted to said data). At least, as explained above, the parameters “position” (for example x, y in a Cartesian coordinate system) and “heading” should be present, but is likely that also derivatives of these quantities could be present. This is especially likely for the vehicle state vector, since many motion models use these derivatives.

For more accuracy of the calculation of the virtual road additionally data taken e.g. from a GPS sensor or from a radar sensor sensing the vehicle's environment can be used.

In one embodiment of the invention, the algorithm performs a fitting, e.g. by a least squares method, of a sequence of cubic splines to the actual trajectory matrix Ak, using the obtained sequence of splines as road state vectors for the virtual road matrix VRk−m). The use of other parametric curves than cubic splines is a suitable alternative. Here, the choice of parametric curves, possible parameter values and the choice of distance between individual splines, can preferably be made based on knowledge of road design.

For example, in one preferred embodiment, cubic splines are spaced by e.g. ca. 20 seconds when the vehicle is travelling at e.g. 70 km/h. Dependent on the speed and/or the used algorithm model, the time period between the measurements can be longer (for instance in the range of ca. 30-50 seconds) or shorter (for instance in the range of ca. 5-15 seconds) than the exemplarily selected 20 seconds.

Further, in an alternative embodiment of the invention, the algorithm may incorporate knowledge about actual models used in road planning e.g. a clothoid model (whose parameterization applies to European roads), for the calculation of the virtual road VR.

Further, in an alternative embodiment of the invention, statistical descriptions of model uncertainties are used in the filtering framework. This can lead to weighted least squares solutions and allows the use of e.g. Kalman filters or extended Kalman filters, or unscented Kalman filters.

In an alternative preferred embodiment, instead of fitting parametric curves to the actual trajectory matrix Ak independent of the calculation of actual trajectory Ak, it is possible to calculate the virtual road matrix VRk-m jointly with the actual trajectory matrix Ak. This can be done e.g. by including the corresponding virtual road state vectors vr1,vr2, . . . vrk−m in a combined state matrix Mk=(a1,a2, . . . ak, vr1,vr21 . . . vrk−m) and using the same model based filtering and non-causal filtering techniques. One example is the Monte Carlo based embodiment mentioned above for the determination of the trajectories, where additionally the driver's maneuvers can be included as possible hypotheses, with associated probabilities.

A further possibility is to use a bank of Kalman filters, for example the IMM (interactive multiple-model) framework or static multiple-model framework, to represent and detect different driver maneuvers or different road properties. Such a filter bank could also be used to determine the actual trajectory or the virtual road respectively.

Detection and identification of intentionally induced maneuvers is preferred in all embodiments of the invention, regardless of how they are detected and identified. More specifically, it is preferable to detect such maneuvers where the driver intentionally induces lateral vehicle movements that are different from the lateral movements occurring during normal attentive driving when the vehicle is following a single lane. Two examples of such maneuvers are lane changes and takeovers. If performed quickly, such maneuvers may include lateral movements that could be interpreted by the system as unintentional deviations from a desired path (Since the resulting actual trajectories have higher bend curvatures than typical roads). Therefore, it is advantageous to detect and to identify these intended maneuvers, e.g. to discard the corresponding portions of data, or to report a corresponding lowered confidence in system output. However, if such an intended maneuvers performed smoothly, the resulting lateral movements can be similar to those generated during normal attentive driving following a single lane, and in these cases it is not necessary to detect the manoeuvre. Rather, it is an advantage of the present invention, compared to previous known solutions using real lane position information (e.g. from a lane tracker camera), that the virtual road can be calculated even if the vehicle is smoothly changing lanes.

As mentioned above, in some preferred embodiments, maneuvers are detected at the same time as actual trajectories and virtual road are calculated, using model-based filtering and non-causal filtering techniques. In other embodiments other detection methods may be used, e.g. rule based methods. The following table 1 shows additional detection possibilities for intentional maneuvers as for instance lane changes and takeovers.

| Manoeuvre | Possible detection method |
|---|---|
| Lane change | Turn indicator activity |
| | Yaw rate profile (large amplitude followed by |
| | similar amplitude with sign change) |
| Overtake | Turn indicator activity |
| | Acceleration profile (both lateral and longitudinal |
| | acceleration pattern of the vehicle) |
| | Radar data (if corresponding radar sensor is present) |

Some embodiments of the invention may also include vehicle position data from a GPS device (not shown), possibly in combination with a road map database which can also be used during the calculation step 6 of the virtual road VR, i.e. for estimating the virtual road. Since in a preferred embodiment also radar data might be available, these radar data can also be used for calculating the virtual road VR.

In calculation step 8 in FIG. 1, the lateral offset d is determined. The determination of the lateral offset d is performed by setting actual trajectory and virtual road in relation to each other.

In a preferred embodiment, the lateral offset is defined as the directional lateral distance dj between actual trajectory state vector aj and virtual road state vector vi-j at time tj. That means, dj is calculated as a “signed lateral distance” between aj and vr-j, i.e. as a scalar having either a positive, a negative or zero value. The absolute value of the scalar is the distance between the positions of vectors aj and vij, and the sign of dj is positive when aj points to one side of vrj, e.g. to the right side of vij relative to the heading of vrj, and a negative value when aj points to the other side of vrj. The lateral distance dj can be computed e.g. as the scalar product δ·n, where δ is the difference between the positions of aj and vrj, and n is a vector that is a normalised (i.e. scaled to have norm one) version of the heading of vrj, rotated 90 degrees clockwise in the horizontal plane compared to the heading of vrj.

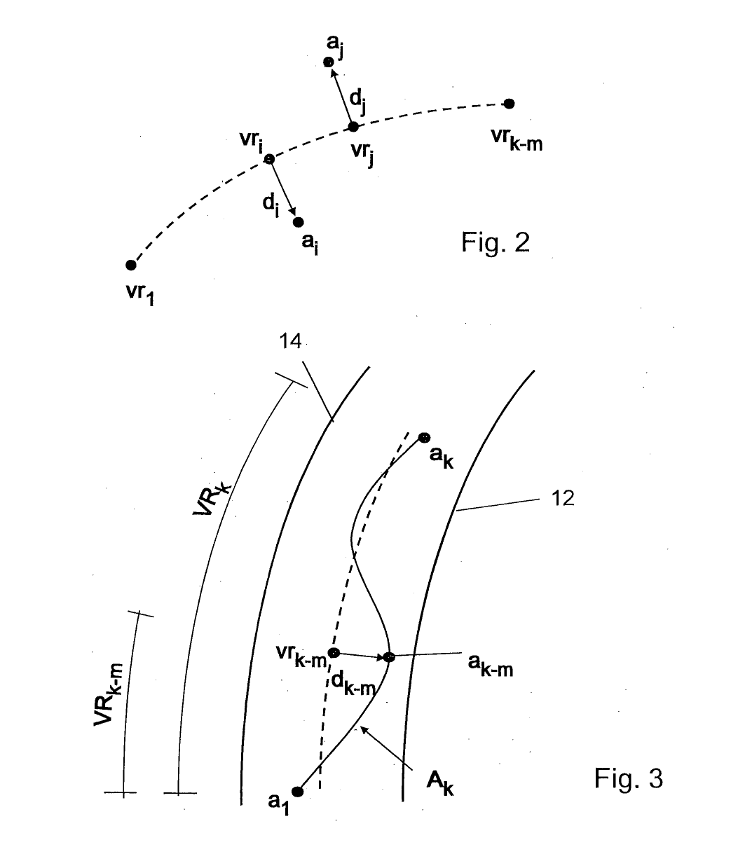

FIG. 2 shows schematically the estimated virtual road matrix VRk.m=(vri,vr2, . . . vrk−m), where exemplarily at times ti=i×TS and tj=ji×Ts the relations between ai, vri, di and aj, vrj, dj are illustrated. As can be seen, FIG. 2 shows two lateral offsets dj and dj at time tj and tj, wherein at time ti ai is on the right side of vri resulting in a directional lateral distance di with a positive value and at time tj at is on the left side of vrj resulting in a directional lateral distance dj with a negative value.

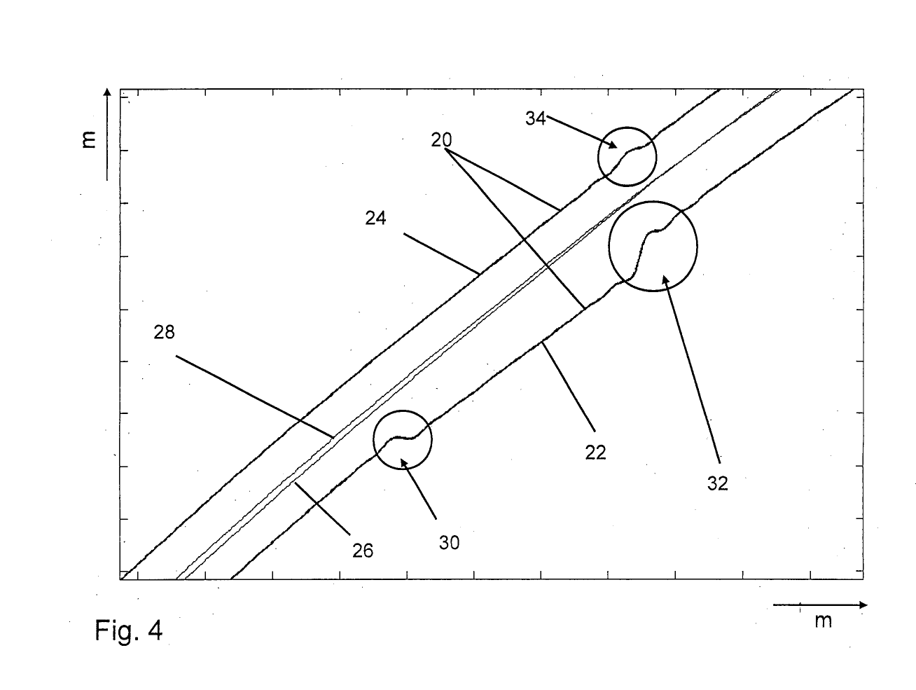

Instead of calculating a relation of actual trajectory and virtual road, it is also possible to output the data concerning actual trajectory and virtual road directly. Alternatively, the data on actual trajectory and virtual road can be output in addition to the calculated lateral offset. What kind of data is used as output can be determined by the requirements of a further system using the output of the inventive system as input. In case the lateral offset is the only output, the inventive system can also be regarded as lane tracker camera, giving its output with a certain time delay. In general, it should be mentioned that the latest data, regarding the time, of the output of the inventive system—and also the data of the actual trajectory—always correspond to the data at a time (k−m)×Ts. The reason for that can be derived from FIG. 3.

FIG. 3 schematically illustrates the relation between actual trajectory matrix Ak and virtual road matrix VRk−m and the lateral offset d. As explained above, the inventive method works by adopting a certain time delay for calculating the virtual road matrix VRk−m. Therefore, the system calculates at time k×TS the actual trajectory matrix Ak comprising vehicle state vectors ai . . . ak. Based on these vectors, the system calculates for a time (k−m)×Ts the virtual road matrix VRk−m. That means at the time (k−m)×Ts, the estimation of the virtual road gives the result that the vehicle is following e.g. a bend in the road as schematically illustrated in FIG. 3. The solid lines 12 and 14 in FIG. 3 can be regarded as right and left margin of the virtual road, respectively. Thereby, it can also be seen that the virtual road vector defines the middle of the lane of the virtual road.

Since, as mentioned above, the virtual road can be regarded as an estimate of the actual road, the virtual road can be used to estimate an optimal path for following the actual road. Then, the lateral offset d can be regarded as a measure of how close the driver manages to stay to the optimal path, wherein in further steps the lateral offset can also be used as a basis for determining whether the driver follows his intended path or whether the vehicle staggers due to driver's inattentiveness.

Naturally, an attentive driver will follow the virtual road quite closely, thereby producing only small lateral offsets or deviations d. The deviations produced can, among others, be caused by weather conditions (S1de wind) and/or small driving corrections with the help of the steering wheel performed by the driver for following the road along the virtual road. An impaired or inattentive driver in turn generates larger and more extreme changes in lateral direction deviations d and lateral speed deviations, wherein it is not the value of the actual distance that matters, but an overall pattern of lateral distance control measured over a certain period of time.

In a further calculation step 10 in FIG. 1 one or more confidence values for the system's calculations are determined. The output from this calculation step 10 is an estimate of the confidence to be attributed to the other output parameters of the system which as explained above may include all or a subset of S, A, VR and d. Confidence estimates may e.g. be given for each output quantity separately, e.g. in the form of a confidence value between zero and one for each, or e.g. as a single overall confidence value based on more than one or all output parameters of the system. Confidence estimation calculations include considerations on sensor data quality, as reported from the sensors themselves and/or as estimated from properties of actual sensor output (e.g. erratic sensor behavior may be detected using e.g. rule based methods). Confidence estimation calculations may further include considerations on detected maneuvers, as described above, since during certain maneuvers (e.g. abrupt lane changes) the virtual road VR may not really reflect the driver's preferred, optimal path for following the actual road. In these cases, consequently the confidence value for the lateral deviation estimates d is also lower. Another issue that can be considered in the confidence estimation calculations is the detection of road geometries that do not follow standard models for road design. Such road geometries can be considered by using additional information typically based on GPS and/or map data.

FIG. 4 shows a diagram with experimentally derived data of the actual trajectory and the calculated virtual road according to the present invention in comparison with data gathered from a lane tracker sensor known from the state of the art, wherein the data are illustrated as a two-dimensional bird view of a road (i.e. seen from above the road) with meters as units for x-axis and y-axis.

Graph 20 of FIG. 4 illustrates a road as seen by a conventional lane tracker system, wherein 22 corresponds to the sensed right lane marking, wherein the line reference by 24 corresponds to the left lane marking.

Graph 26 of FIG. 4 illustrates an actual trajectory A as determined by the inventive system and method, wherein the actual trajectory is determined by vehicle position and vehicle heading. Based on the data of the actual trajectory and known physical road constraints, as explained above, the inventive system determines a virtual road VR. The middle of the virtual road as defined by the virtual road state vector is illustrated by graph 28. In case the road comprises more than one lane, the virtual road would correspond to the middle of a single lane.

A comparison between graph 20 and graph 26 shows that the course of the actual road as sensed by the lane tracker sensor and the course of the virtual road are very similar. It can also be seen that the inventive system and method has the advantage that the determination of the virtual road is not affected by measurement failures or uncertainties as it happened with the known lane tracker system (indicated in FIG. 4 by the circles 30, 32, and 34). These measurement failures or uncertainties are due to the fact that the lane tracker sensor sometimes fails to sense the lane marking (see for instance 34) or takes the end of the tarmac as lane marking (see for instance 30 and 32). In contrast to that, the virtual road as determined by the inventive system precisely follows the actual road shape.

The comparison between the values of the known lane tracker and the data obtained from the inventive method shows that the replacement of a conventional lane tracker system by the inventive method and system is not only technically possible but shows also better and more robust results when determining road data for a road a vehicle is travelling on provided that a longer time scale in the order of minutes or seconds instead of milliseconds is allowed for the determination of the road data.

1. Method for determining road data comprising the steps of:
Measuring variables (S) suitable for determining an actual trajectory (A) of the vehicle;
Determining the actual trajectory (A) from the measured variables (S); and
Estimating road geometry values based on the determined actual trajectory (A), and
Determining a virtual road (VR) the vehicle is following based on the estimated road geometry values and the actual trajectory (A).

2. Method according to claim 1, wherein for estimating road geometry values and/or for determining the virtual road (VR), knowledge of road design practice and/or typical physical constraints on roads are used.

3. Method according to any of claim 1 or 2, wherein estimated road geometry values are included in a model, such as parametric curves, wherein the parametric curves are preferably cubic splines and/or clothoids and/or combinations thereof.

4. Method according to any preceding claim, wherein the measured variables (S) for determining the actual trajectory (A) comprise sensed vehicle data, particularly vehicle speed data and/or vehicle yaw rate data and/or vehicle position data and/or vehicle acceleration data and/or vehicle yaw angle data.

5. Method according to any preceding claim, wherein the determination of the actual trajectory (A) is performed by applying linear and/or non-linear filtering algorithms on the measured variables (S).

6. Method according to claim 3, wherein the determination of the virtual road (VR) is performed by fitting of the model to the actual trajectory, wherein the fitting is preferably performed by weighted or non weighted least squares optimization, and/or the fitting is performed by applying liner and/or non-linear filtering algorithms on the actual trajectory (A).

7. Method according to claim 5 and/or 6, wherein the filtering algorithms are either filtering algorithms comprising a single hypothesis filter, preferably a minimum mean squared error estimator and/or a linear and/or a linearized filter, particularly a Kalman filter or an extended or an unscented Kalman filter, or filtering algorithms which are capable of handling multiple hypotheses, such as a bank of Kalman filters, particularly a bank of extended and/or unscented Kalman filters, or Monte Carlo methods, particularly particle filters.

8. Method according to any preceding claim, wherein the determination of the virtual road (VR) is performed jointly with the determination of the actual trajectory (A).

9. Method according to any preceding claim, wherein for determining the virtual road (VR) further road information, in particular GPS data of the vehicle position and/or road map data are taken into account and/or information on an individual driving behaviour of at least one driver are taken into account wherein said driving behaviour is preferably stored in a database as part of said driver's profile.

10. Method for determining a lateral offset (d) of a vehicle following an actual trajectory (A) based on the virtual road (VR) characterized in that actual trajectory (A) and virtual road (VR) are determined by a method according to any one of claims 1 to 10.

11. Method according to claim 10, further comprising the step of determining whether the lateral offset (d) is in a predetermined range.

12. Method according to claim 11, wherein for the determination of the predetermined range of the lateral offset (d) possible driver's intended manoeuvres, such as overtaking and/or lane changing, and/or information on an individual driving behaviour of at least one driver are taking into account, wherein said driving behaviour is preferably stored in a database as part of said driver's profile, and/or the amount and/or shape of the lateral offset (d) attributable to such intended manoeuvres and/or driver's individual driving behaviour is/are analysed.

13. Method according to any one of claims 10 to 12, wherein at least one of the determined lateral offset (d), actual trajectory (A) and virtual road (VR) data are used as basis for evaluating a driver's inattentiveness.

14. System for determining road data of a road on which a vehicle is travelling characterised by comprising a calculation unit for performing the steps of a method according to any one of claims 1 to 13.

15. System according to claim 14, comprising a sensor for sensing vehicle speed data, particularly a speedometer, and/or a sensor for sensing vehicle yaw rate data and/or a GPS device providing vehicle position data and/or road map data and/or means for detecting a driver's manoeuvre, particularly an activation of a turn indicator for detecting an overtake and/or a lane change, and/or devices or arrangements for determining an acceleration profile for detecting an overtake.

16. System for detecting a driver's inattentiveness comprising a system according to any one of claims 14 to 15 using a method according to any one of claims 1 to 13.

17. Computer program product comprising a software code adapted to perform a method or for use in a method according to at least one of claims 1 to 13 wherein said program is run on a programmable microcomputer, and/or wherein the computer program is preferably adapted to be downloaded to a support unit or one of its components when run on a computer which is connected to the internet.

18. A computer program product stored on a computer readable medium, comprising a software code for use in a method according to one of claims 1 to 13 on a computer.
